(19) United States
(12) Patent Application Publication
(10) Pub. No.: US 2024/0086458 A1
(43) Pub. Date: Mar. 14, 2024

(54) Mobile app for herbarium and live plants

(71) Applicant: Li Shao, SAMMAMISH, WA (US)

(72) Inventor: Li Shao, SAMMAMISH, WA (US)

(73) Assignee: Pacific Technology and Resources LLC, Sammamish, WA (US)

(21) Appl. No.: 18/243,101

(22) Filed: Sep. 7, 2023

Related U.S. Application Data
(60) Provisional application No. 63/404,960, filed on Sep. 9, 2022.

(51) Int. Cl. G06F 16/58; G06F 16/54; G06Q 20/32

(52) U.S. Cl. CPC G06F 16/58; G06F 16/54; G06Q 20/322; G06Q 2220/18

(57) ABSTRACT

The invention uses mobile app technology to make herbarium information available on devices with easy-to-use interfaces. With the mobile app, the herbarium information is more easily accessible. This portion of the invention was disclosed in Provisional Application No. 63/404,960, filed on Sep. 9, 2022. This invention further supports the functionality to add new herbarium and/or live plant images. A user can use machine learning technology to identify the plant in the image or add taxonomic information with the aid of autocompletion feature. The invention allows a user to specify licenses for images. The images can be displayed to other users for information sharing, purchase and download. There is also a functionality to show only herbarium or live plant images in the app. This portion of the invention was not disclosed in Provisional Application No. 63/404,960 and built upon the foundation established by Provisional Application No. 63/404,960.

### CROSS-REFERENCE TO RELATED APPLICATIONS

This nonprovisional patent application claims the benefit of the filing date of Provisional Application No. 63/404,960, filed on Sep. 9, 2022, titled ‘Mobile app for Herbarium’. The subject matter disclosed in the Provisional Application, specifically claims 1-5 in this nonprovisional application, is hereby claimed with the priority date of Provisional Application No. 63/404,960.

The present nonprovisional application includes additional features and subject matter that were not disclosed in the referenced Provisional Application. These additional features, as referenced by claims 6-14 in this nonprovisional application, are not entitled to the priority date of Provisional Application No. 63/404,960 and have their own priority date as of this nonprovisional application filing date. The entire contents of Provisional Application No. 63/404,960 are incorporated by reference for the purpose of claiming priority to the disclosed subject matter therein, but not for the new features.

### BACKGROUND/SUMMARY

### Background of the Disclosure

Herbarium plays an important role in plant identification, taxonomy and in understanding and preserving biodiversity. Within the last decade, there have been efforts to digitize the vast collection of herbaria in different institutions. Many of these digitized herbaria are available online through different portals. The examples of these portals include Kew Gardens and New York Botanic Garden Herbarium.

This invention makes the herbarium data available on mobile devices, providing a dedicated system and a much more user-friendly interface to access herbarium data. With the mobile app, the herbarium information is more easily accessible by the professional botanists, researchers, students as well as general public, such as museum visitors or just anyone with a mobile device. It also provides an infrastructure that can potentially centralize the herbaria from different organization and the user can selectively download the herbaria from certain organizations.

In addition to herbarium, with the widespread use of digital technology, another form of abundantly available source of plant data is digital live plant images. These plant images, however, are not organized and/or classified in many situations. Moreover, there isn't a dedicated, streamlined process for people such as professionals, amateur enthusiasts to share and make use of these images.

With the image uploading, identifying, licensing, sharing or purchasing features disclosed in this nonprovisional application, it makes it easy to contribute to herbarium collection and live plant images collection. It provides a platform for professionals and amateur botany enthusiasts around the world to contribute, share and potentially monetize their images.

### Description

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an illustrative representation of the cloud data storage and the mobile app on user devices according to one embodiment.

FIG. 2 is a screenshot for downloading the data to a user device for specific regions according to one embodiment.

FIG. 3 is an illustrative representation for downloading the data to a user device for specific organizations according to one embodiment.

FIG. 4 is a screenshot of the UI displaying the herbarium/plant images categorized by their families according to one embodiment.

FIG. 5 are screenshots of the search functionalities in the UI displaying the herbarium/plant images categorized by their families according to one embodiment.

FIG. 6 is a screenshot of the UI displaying the detailed view of the herbarium/plant image according to one embodiment.

FIG. 7 is a screenshot of the UI for filtering the herbarium/plant images based on the regions according to one embodiment.

FIG. 8 is a screenshot of the UI for filtering the herbarium/plant images based on the families according to one embodiment.

FIG. 9 is a screenshot of the UI for adding new herbarium/plant image according to one embodiment.

FIG. 10 is a screenshot of the UI of the new herbarium/plant image and its detailed information according to one embodiment.

FIG. 11 are the screenshots illustrating the process to fill in taxonomic information according to one embodiment.

FIG. 12 is a screenshot of the UI for fill in region information according to one embodiment.

FIG. 13 are the screenshots illustrating the process of using machine learning to identify the live plant in the image and filling in taxonomic information according to one embodiment.

FIG. 14 are the screenshots illustrating the process of uploading images and start payment process according to one embodiment.

FIG. 15 are the screenshots illustrating the process of setting up creative common licenses for image according to one embodiment.

FIG. 16 are the screenshots illustrating the process of setting up royalty-free licenses for image according to one embodiment.

FIG. 17 is a screenshot of the UI displaying the uploaded herbarium and live plant images according to one embodiment.

FIG. 18A is a screenshot of the UI with the detailed view of the uploaded herbarium according to one embodiment.

FIG. 18B is a screenshot of the UI with the detailed view of the uploaded live plant image according to one embodiment.

FIG. 19 are the screenshots illustrating the process of making payment and downloading the image according to one embodiment.

FIG. 20A is the screenshot of not uploaded image without the taxonomic information according to one embodiment.

FIG. 20B is the screenshot of not uploaded image with the taxonomic information according to one embodiment.

FIG. 21 is a screenshot of options to display herbarium and/or live plant images according to one embodiment.

FIG. 22 is a screenshot of options to pay to download according to one embodiment.

### DETAILED DESCRIPTION OF THE DISCLOSURE

Before turning to the figures which illustrate example embodiments, it should be understood the application is not limited to the details or methodology set forth in the following description or illustrated in the figures. It should also be understood that the phraseology and terminology employed herein is for the purpose of description only and should not be regarded as limiting.

The term ‘cloud,’ as used in this patent application and Provisional Application No. 63/404,960, filed on Sep. 9, 2022, pertains to a dynamic and evolving computing infrastructure that offers scalable, on-demand access to a shared pool of configurable resources. It encompasses a wide range of computing elements, accessible remotely over networks, and is adaptable to evolving standards, deployment models, and service offerings within the field of cloud computing.

In this patent application and Provisional Application No. 63/404,960, filed on Sep. 9, 2022, it is to be understood that the term ‘cloud’ represents but one variant of network-based storage solutions among a diverse array of available options. Network-based storage encompasses various configurations, including but not limited to cloud storage, private servers, edge storage, distributed storage systems, remote servers, and network-attached storage (NAS), all of which facilitate the remote storage and retrieval of data across interconnected devices and servers.

The term ‘region’, as used in this patent application and Provisional Application No. 63/404,960, filed on Sep. 9, 2022, is used in a global context and is intended to encompass geographical areas and territories across the world. It includes, but is not limited to, regions within continents, countries, states, provinces, cities, and any other geographical divisions or designations worldwide. The use of ‘region’ is not restricted to any specific location and is applicable universally.

As one embodiment of the disclosure in this patent application and Provisional Application No. 63/404,960, filed on Sep. 9, 2022, the level 2 regions defined by International Working Group on Taxonomic Databases for Plant Sciences (TDWG) (https://www.tdwg.org/standards/wgsrpd/) is presented; however, it should be noted that the scope of this invention is not restricted exclusively to the level 2 regions. Rather, the level 2 regions are provided as an illustrative example and is not exhaustive. The invention encompasses a broader range of regions that share similar characteristics, functions, or attributes as the level 2 regions, thereby allowing for variations and alternatives within the defined scope.

In an embodiment of the disclosure in Provisional Application No. 63/404,960, filed on Sep. 9, 2022, herbarium information and/or live plant images data are stored in the cloud. Once the user chooses a region to download the image data, a request will be sent to the cloud and the relevant region-specific data will get downloaded onto the device. The information is stored in the local database owned by the mobile app. The mobile app will then use these data to populate the UI for displaying and searching of herbarium and/or live plant images.

In an embodiment of the disclosure of the present application, a user can use the app to take image or load existing images from the device. The app can use machine learning to identify the plant in the image. The success rate and the accuracy of this functionality will improve with the overall advancement of the machine learning technology in image identification area. The user can rely on autocompletion feature to add/edit the taxonomic details. Region information can get auto-populated if the image location information is available to the app.

In an embodiment of the disclosure of the present application, a user can upload the image to the cloud. They may be prompted to set up license information so that the image can be shared with others. The uploaded image will be available to download by other users of the app. Once making payment, a user can download the image to their own device.

In another embodiment of the disclosure in Provisional Application No. 63/404,960, filed on Sep. 9, 2022, herbarium, live plant image data and/or region may be stored on the local device.

In another embodiment of the disclosure in this present application, region and/or taxonomic data may be stored on the local device.

In another embodiment of the disclosure in the present application, the mobile application can be crafted based on the disclosure so that there is no need to set up licenses and/or the pay to download process, while the users can still share the images.

In another embodiment of the disclosure in the present application, the licenses set up and/or pay to download process as disclosed in this present application can be accomplished through other software forms, such as, but not limited to, web application, desktop application, in addition to mobile application.

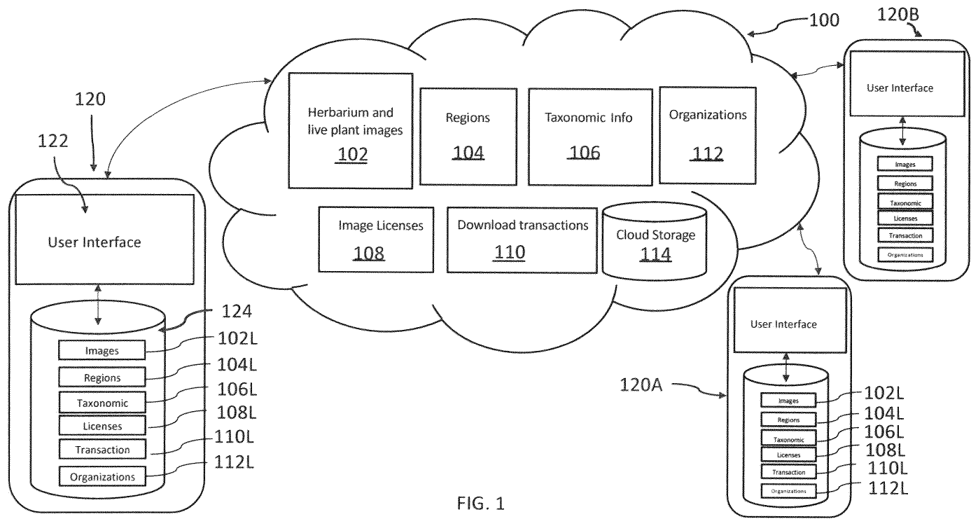

Referring to FIG. 1, according to one embodiment, cloud (100) is used to store the herbarium and live plant image data. It contains herbarium and live plant data (102), region data (104) and potentially data for different organizations (112) if the herbaria are from different sources. Region data is based on International Working Group on Taxonomic Databases for Plant Sciences (TDWG) (https://www.tdwg.org/standards/wgsrpd/).

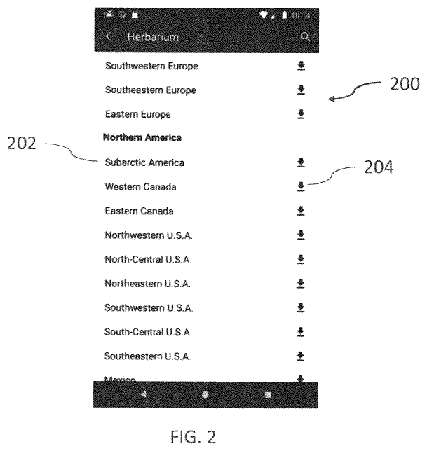

Referring to FIG. 2, according to one embodiment, once the user logs into the mobile app through UI (122) on a mobile device (120), region information (104) will be downloaded to the local region table (104L) inside the local database (124) if they are not present. The user will be presented with the list of regions around the world (200) based on the information in the local regions table (104L). The user can choose to download the image data from cloud (100) for certain regions (202) by clicking on download button (204). Region specific herbarium and live plant image data (102) will be downloaded and stored in the local database (102L).

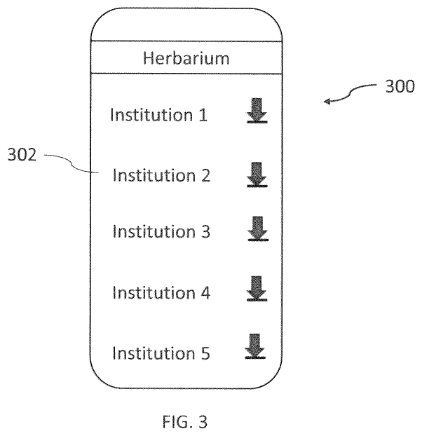

Referring to FIG. 3, if the herbarium or live plant image data are from multiple sources, for example, different institutions, the organization information can be saved in the cloud (112). An organization specific download UI (300) can be used to download data specific to certain organization (302) and save them into the local table (112L). This is one of the embodiments of how the technology can be used. For the rest of the description, region specific data from FIG. 2 will be used for illustration purposes.

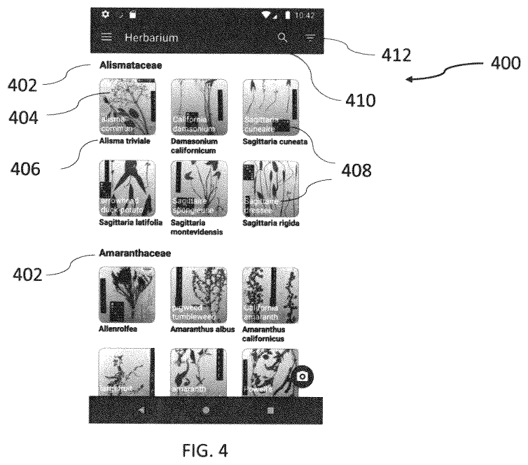

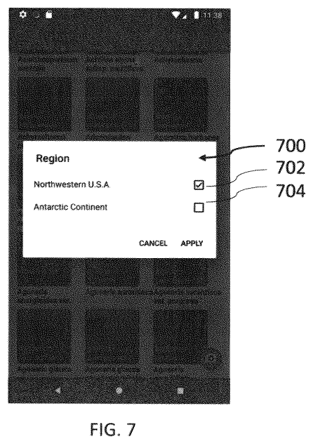

Referring to FIG. 4, according to one embodiment, the region-specific image data will then be used to display the herbarium and live plant images on a grid UI (400). Each grid element contains the image of an herbarium or a live plant image (404), its scientific name (406), common name (408) if available. They are organized by family (402). Clicking on 412 can bring up the UI for filtering region as described below in FIG. 7.

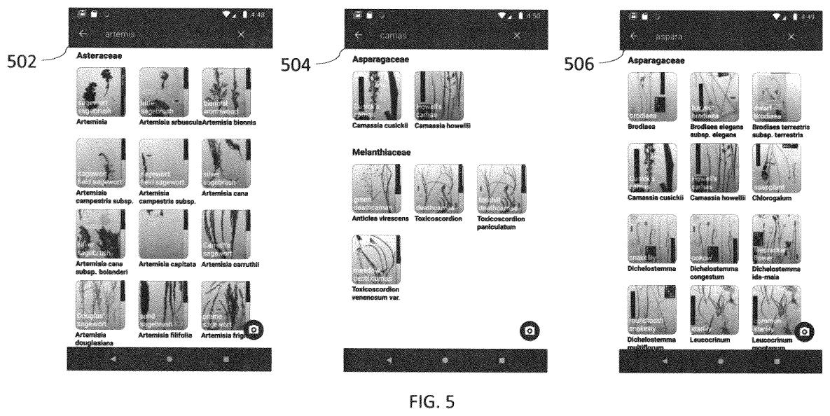

Referring to FIG. 5, according to one embodiment, clicking on search icon 410 in FIG. 4 will bring up search UI. A user can search by full or partial match of scientific name (502), common name (504) or family name (506).

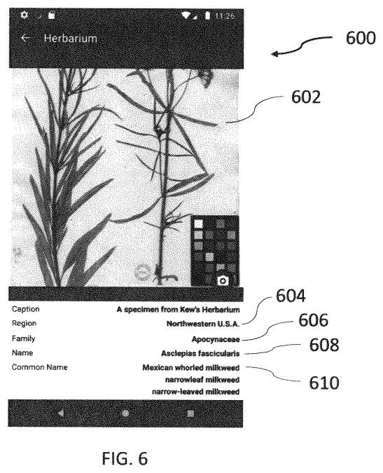

Referring to FIG. 6, according to one embodiment, on user action (single click of a grid element), a detailed view (600) will be brought up. The user can see the detailed image (602) and additional information such as region (604), family (606), scientific name (608) and common name(s) (610) if available. A user can zoom in and out of the image in the detailed view. A user can also use swipe left or right gesture to navigate to the detailed views of the adjacent images.

Referring to FIG. 7, according to one embodiment, a user can choose to show only one or a few specific regions (700) in the app by selecting (702) or deselecting (704) of the region. A user also has the option to download additional regions while in the app by invoking download UI (200 in FIG. 2).

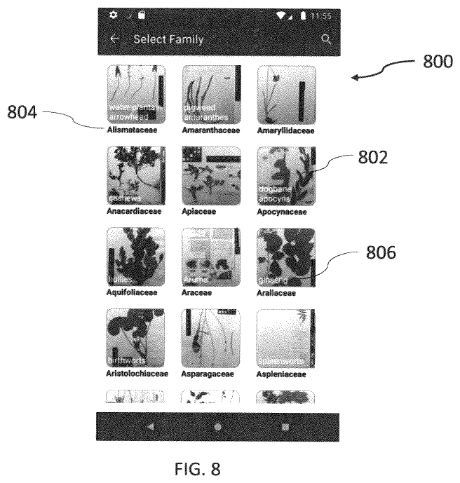

Referring to FIG. 8, according to one embodiment, a user can choose to show one or a few specific families of the herbarium and live plant images using select family UI (800). It displays the image (802) of one of the family members for each family, the scientific name of the family (804) and common name of the family (806) if it is available. Search by family scientific name or common name features are also available.

The above functionalities were disclosed in Provisional Application No. 63/404,960, filed on Sep. 9, 2022.

This nonprovisional application, based upon Provisional Application No. 63/404,960, filed on Sep. 9, 2022, discloses a new set of features for uploading and downloading herbarium and live plant images.

Referring to FIG. 1, according to one embodiment, cloud (100) contains plant taxonomic information (106), image licenses (108), download transactions (110). It also contains a cloud storage for uploaded image files (114). Upon user log in and region selection as described in FIG. 2, taxonomic information (106), image licenses (108) and download transaction information (110) will be downloaded into local table 106L, 108L and 110L, respectively, if they are not present.

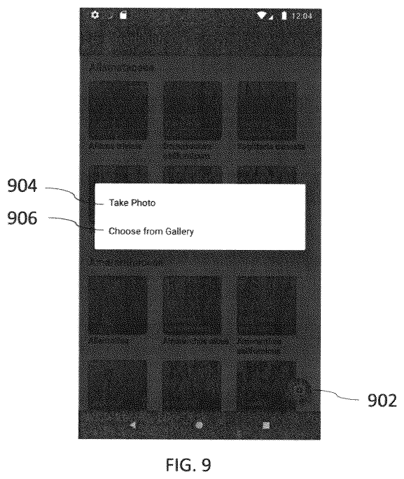

Referring to FIG. 9, according to one embodiment, to add new images of herbarium or live plants, a user can click on the button (902). There will be a dialog with options to take photo (904) or choose existing image (906).

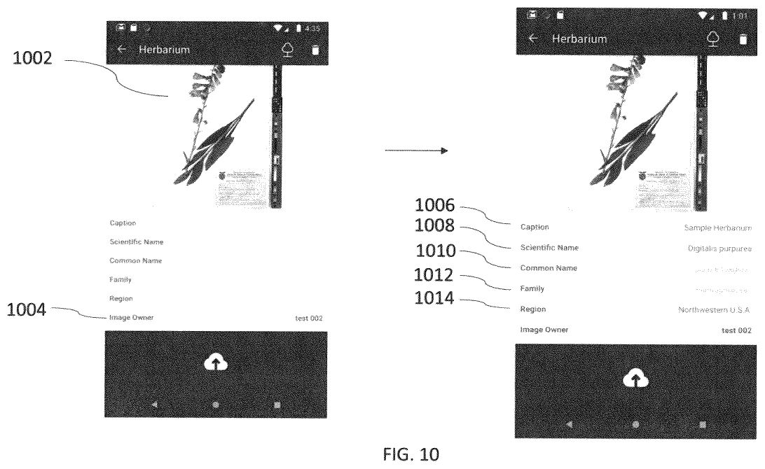

Referring to FIG. 10, according to one embodiment, once the image is loaded into the UI (1002), Image owner field (1004) is auto-populated with the logged in user profile. A user can add or edit detailed information such as image caption (1006), scientific name (1008), common name (1010), family name (1012) and region (1014). For scientific name, common name or family name field, autocompletion list will show up as the user types.

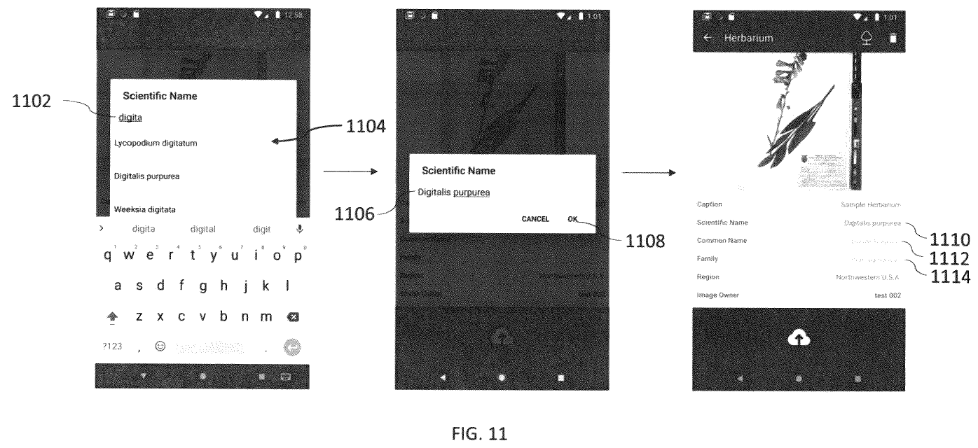

Referring to FIG. 11, it illustrates the process for auto-completion of scientific name according to one embodiment. As the user types in the autocompletion edit box (1102), an autocompletion list (1104) will appear. The user can complete from the list to get the scientific name (1106). Once the user confirms the scientific name by clicking on OK button (1108), Scientific name field (1110) will be filled with the value of 1106. Common name (1112) and family name (1114) fields will be auto-populated. The auto-completion and auto-population information are based on the taxonomic data table (106L in FIG. 1). The information of this table is downloaded from 106 (FIG. 1) when the user logs into the app for the first time.

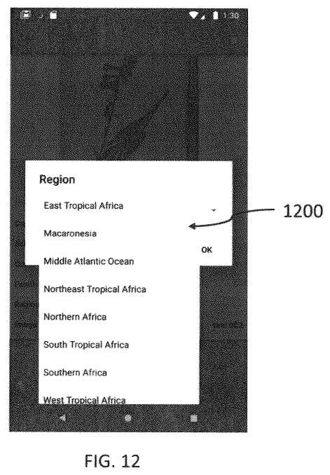

Referring to FIG. 12, when a user clicks on region field (1014 in FIG. 10), according to one embodiment, a list of level 2 regions of TDWG (1200) is available for the user to make selection. The information for the list is coming from the region table (104L in FIG. 1), which is downloaded from cloud database table 104 (FIG. 1) upon user log in.

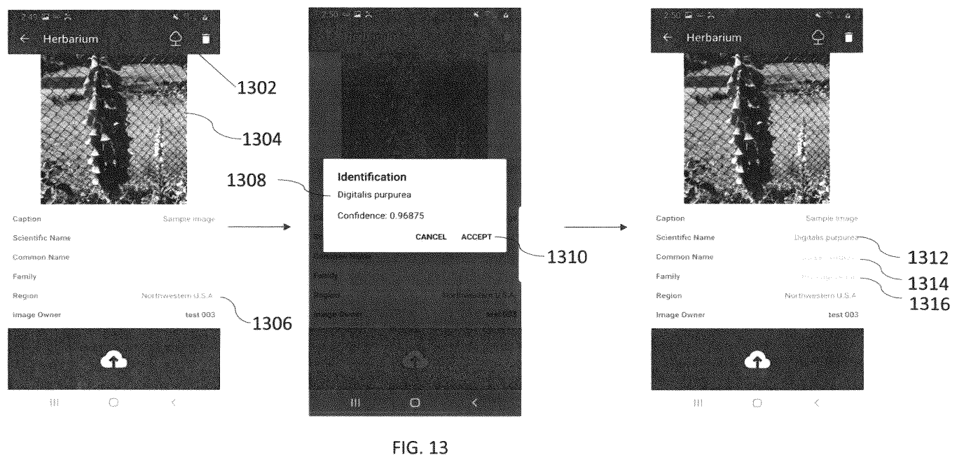

Referring to FIG. 13, according to one embodiment, in the case of live images, if having user permission to access location data, the region information (1306) will be auto-populated based on the image's (1304) location data and information in the region table (104L). For live plant images and possibly herbarium images, a user can use machine learning to automatically fill in the taxonomic details. According to one embodiment, clicking on icon 1302 will trigger the process to identify the plants in the image. If successful, user will get the scientific name (1308) of the plant. Once the user accepts the results by clicking on button 1310, scientific name field (1312) will be filled in as the value in 1308. Common name (1314) and family name (1316) will be auto-populated based on the scientific name (1312) and the information in the taxonomic table (106L in FIG. 1), which is downloaded from cloud database table 106 (FIG. 1) upon user log in.

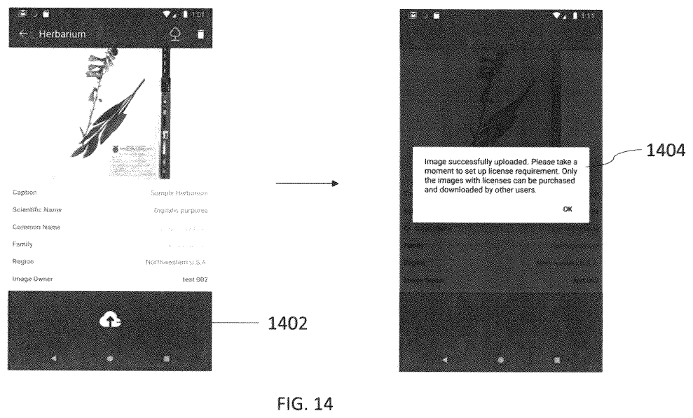

Referring to FIG. 14, when a user clicks on upload icon (1402), an upload process will start. According to one embodiment, the upload process will store the image in the cloud storage (114 in FIG. 1). It will also add an entry into herbarium and live plant images table (102 in FIG. 1). Once the upload is completed, the user will be prompted to add license for the image. 1504 is a sample message according to one embodiment.

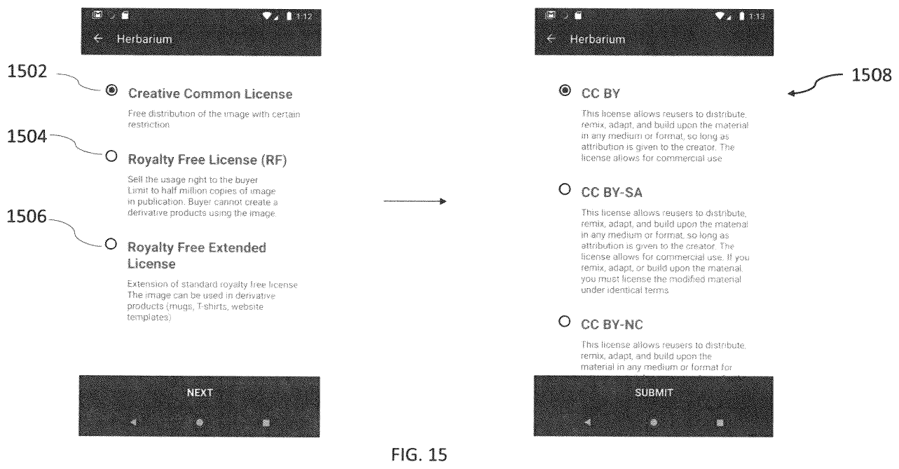

Referring to FIG. 15, according to one embodiment, a user can choose to add Creative Common Licenses (1502), Royalty Free License (1504) or Royalty Free Extended License (1506). If the user chooses to add Creative Common (CC) License, they can choose the specific type of CC licenses as in 1508.

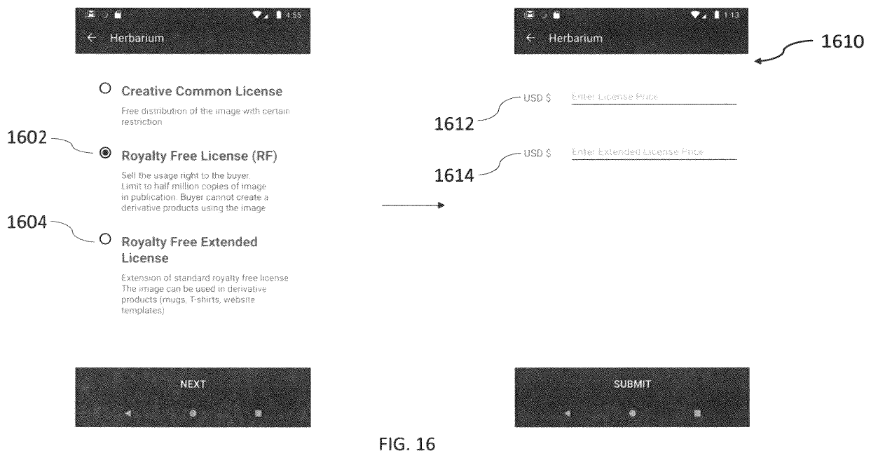

Referring to FIG. 16, according to one embodiment, if the user chooses to add Royalty Free License (1602) or Royalty Free Extended License (1604), a new UI (1610) will come up where they can set price for Royalty Free License (1612) and/or Royalty Free Extended License (1614). Once the license is submitted, a new entry will be added to the cloud image license table (108 in FIG. 1).

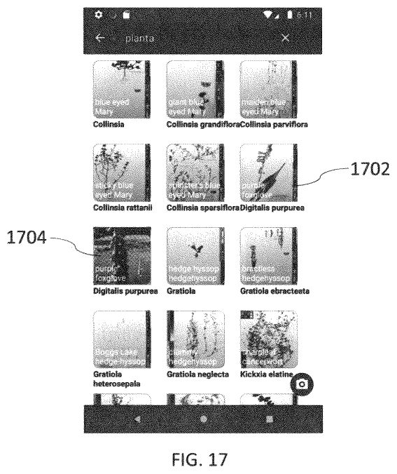

Referring to FIG. 17, according to one embodiment, the newly added images and license information will be automatically propagated to apps on other devices that are logged into the cloud illustrated as 120A, 120B in FIG. 1. The current user as well as other users will be able to see the newly upload image of herbarium (1702) and live plant (1704).

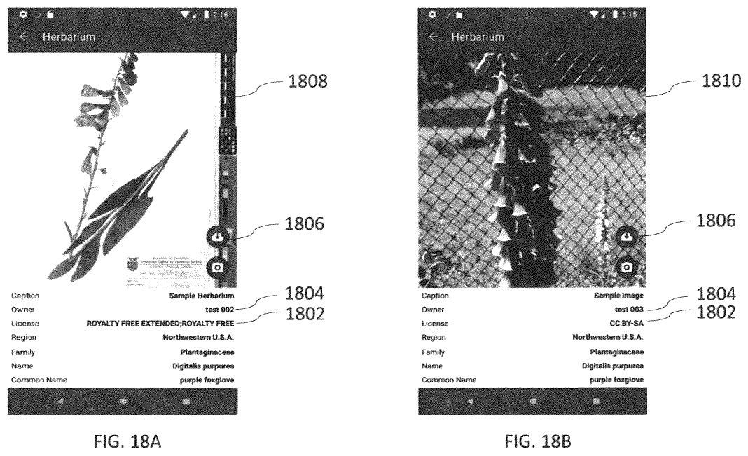

Referring to FIGS. 18A and 18B, according to one embodiment, once the user clicks on 1702 or 1704 in FIG. 17, they can see the detailed page of the herbarium (FIG. 18A) or live plant (FIG. 18B). The detailed page shows the license types (1802), license owner (1804) in addition to other details for the herbarium (1808) or live plant (1810) in the image such as caption, region, family, scientific name and common name. There is a download button (1806) if there is a license associated with the image. Once the user clicks on the download button (1806), if they are not the owner of the license, they will be prompted to go through a payment process to pay for the license if there are prices associated with the license(s) and/or if there are other fees collected by the app itself.

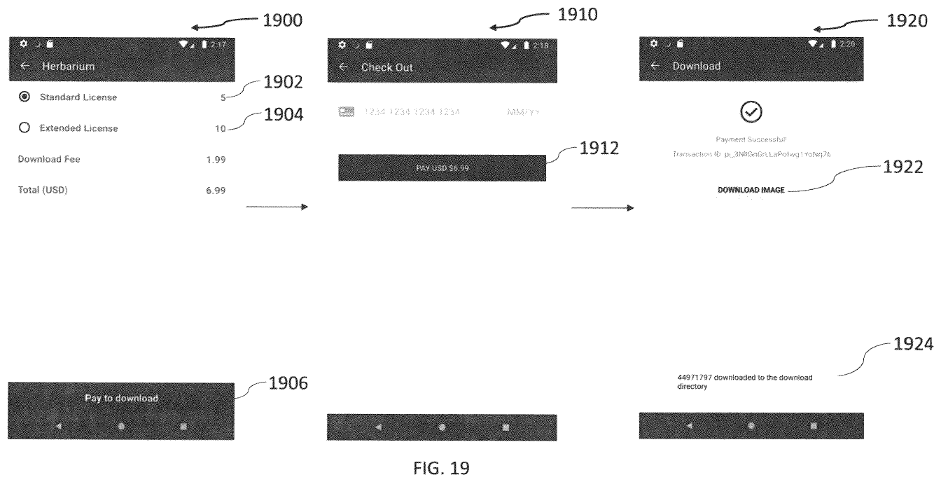

Referring to FIG. 19, according to one embodiment, in UI 1900, 1902 is the standard license fee and 1904 is the extended license fee set by the license owner. Once the user clicks on button 1906, a payment UI (1910) will come up for them to pay by clicking on button 1912. Once the payment is finished, download image button (1922) will show up on a new UI (1920). After the user clicks on 1922, the image file will get downloaded to the user's device and a file downloaded message (1924) will be displayed to the user.

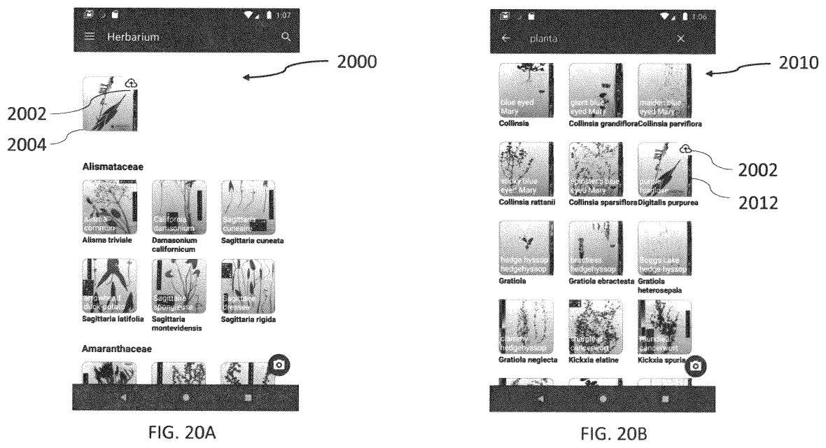

Referring to FIGS. 20A and 20B, before filling out the detailed information and uploading the image as illustrated from FIG. 10 to FIG. 19, a user has the option to save the image onto local device and fill out detailed information and upload later. According to one embodiment, an icon (2002) will be displayed on the image to indicate that the image is not uploaded yet. 2004 in FIG. 20A is an example if the image does not have the detailed information such as family, scientific name and common name filled out. It will be placed in its own category in the UI (2000). 2012 in FIG. 20B is an example if the image has detailed information such as family, scientific name and common name filled out. It will be placed in the list UI (2010) based on its family and its scientific name. Once the user clicks on the image (2004 or 2012) in the list UI, the image with the detailed information as the user filled out will show up as in FIG. 10. The user can add and/or edit the detailed information and start the upload process by following the process illustrated from FIG. 10 to FIG. 19.

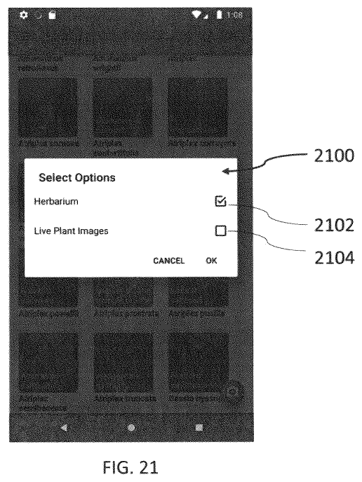

Referring to FIG. 21, according to one embodiment, a user can also choose to show only herbarium images (2102) or live plant images (2104) in the app by picking options in 2100.

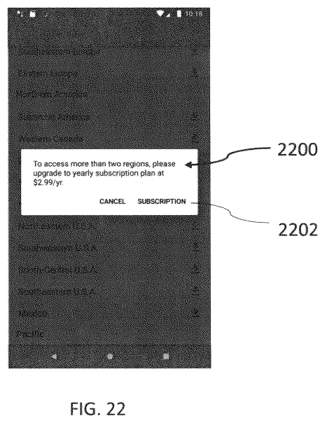

Referring to FIG. 22, according to one embodiment, a user will be prompted to pay for subscription (2200) if they have reached the quota for the number of free downloaded regions. Click on subscription (2202) will start the subscription process.

1. A mobile application for herbarium and live plants, comprising:
a) A user interface (UI) configured to display herbarium and/or live plant images along with their taxonomic information including, but not limited to common name(s), categorized by their classifications;
b) A UI configured to display the detailed image of the herbarium and/or live plants;
c) A UI configured to search the herbarium and/or live plant images based on full or partial match of taxonomic information.

2. A mobile application for herbarium and live plants, comprising:
a) A UI configured to contain different regions as specified in the specification section;
b) A UI configured to let the user choose to download image data from one or multiple regions.

3. A method for displaying partition specific herbarium and/or live plant images, with region and institution as two embodiments of partition, comprising:
a) A server configured to store and dispatch information;
b) A UI configured to let the user choose to download partition specific data.

4. A method for displaying herbarium and/or live plant images from different regions, comprising the steps of:
a) Downloading the herbarium and/or live plant images from one or more regions (2.a and 2.b);
b) Displaying the herbarium and/or live plant images (1.a, 1.b and 1.c).

5. A system for displaying herbarium and/or live plant images for different regions, comprising:
a) A processor;
b) A memory storing instructions executable by the processor to:
a. Downloading the herbarium and/or live plant images from one or more regions (2.a and 2.b);
b. Displaying the herbarium and/or live plant images with display module (1.a, 1.b and 1.c).

6. The mobile application for herbarium and live plants, comprising:
a) A UI configured to let the user take a new herbarium and/or live plant image or load an existing image into the mobile application;
b) A UI configured to let the user add or edit detailed information related to the plant in the image;
c) A UI configured to let the user save the image on the local machine and upload later.

7. The mobile application of claim 6, wherein 6.b, further comprises:
a) An identification module configured to use machine learning to identify the plant in the image;
b) A UI configured to autocomplete other taxonomic information including, but not limited to, common name and family name, based on the identification from 7.a.

8. The mobile application of claim 6, wherein 6.b, further comprises:
a) A UI configured to autocomplete plant taxonomic information including, but not limited to, scientific name, common name and family name, as the user types in the editing UI;
b) A server configured to store and dispatch information related to plant taxonomy information.

9. The mobile application for herbarium and live plants, comprising:
a) A UI with the list of licenses including, but not limited to, Creative Common License, Royalty Free License, Royalty Free Extended License, for user to choose and/or set price;
b) A server configured to receive, store and dispatch information related to license information.

10. The mobile application for herbarium and live plants, comprising:
a) A UI to pay for the license and/or download the image after the payment;
b) A server configured to receive, store and dispatch information related to download payment transaction.

11. A method for sharing images with licenses, comprising the steps of:
a) Specify the license type and license fees for an image if applicable;
b) Upload the image with license information to the server;
c) Display the image to other logged in users;
d) Make download available to other users once they have made payment if applicable.

12. A system for sharing images with licenses, comprises:
a) A processor;
b) A memory storing instructions executable by the processor to:
a. Specify the license type and license fees for an image if applicable;
b. Upload the image with license information to the server;
c. Display the image to other logged in users;
d. Make download available to other users once they have made payment if applicable.

13. The mobile application for herbarium and live plants, comprises:
a) A UI configured to let a user choose whether to display both herbarium and live plant images, or display herbarium only or live plant images only.

14. The mobile application for herbarium and live plants, comprises:
b) A UI configured to let a user pay to download any additional regions once reaching the free quota.
